(19) United States
(12) Patent Application Publication
(10) Pub. No.: US 2007/0155265 A1
(43) Pub. Date: Jul. 5, 2007

(54) Aircraft insulation

(76) Inventor: Jerry C. Anderson, Westminister, SC (US)

Correspondence Address: DORITY & MANNING, P.A., POST OFFICE BOX 1449, GREENVILLE, SC, 29602-1449, US

(21) Appl. No.: 10/891,418

(22) Filed: Jul. 14, 2004

Related U.S. Application Data
(63) Continuation of application No. 09/597,326, filed on Jun. 19, 2000, now abandoned.

(51) Int. Cl. B32B 5/26; B32B 27/12; B32B 27/04

(52) U.S. Cl. 442/35; 442/38; 442/49; 442/203; 428/362; 428/369; 428/920; 428/921; 57/204; 57/205; 57/282; 57/284

(57) ABSTRACT

An insulation blanket for use in aircrafts is provided. In one embodiment, the insulation blanket contains an insulation layer sandwiched between two barrier layers. The barrier layers can be made from a vapor-permeable polymer film that is attached to a scrim. The scrim is formed from generally flame-retardant, textured yarns.

### BACKGROUND OF THE INVENTION

Various types of aircraft, such as commercial passenger airline jets, can experience large temperature differentials between the inside and the outside of the fuselage. Moreover, the inside of aircraft can also experience enhanced noise levels due to various factors, such as wind and aircraft vibrations. As such, most aircraft currently employ “insulation blankets” to moderate the interior temperature of the aircraft and provide noise insulation. These insulation blankets generally provide thermal and acoustic insulation and are placed into the air space or cavity between the fuselage skin panels and the interior panels.

One problem with some conventional insulation blankets, however, is moisture intake. For example, moisture can become entrapped within the insulation blanket and condense when colder temperatures are attained. The presence of water within the insulation blanket can undesirably increase the weight of the aircraft, while also reducing the thermal and acoustic performance as well.

In response to these problems, some insulation blankets were developed with a moisture barrier to allow vapors to flow through the blanket. For instance, nylon scrims are currently used as the moisture barrier for many insulation blankets. However, the moisture barriers of these insulation blankets are not generally flame retardant, and thus, will readily burn when contacted with fire. Moreover, many of these insulation blankets also do not provide sufficient noise or thermal insulation.

As such, a need currently exists for an insulation blanket for use in aircraft. In particular, a need exists for an insulation blanket for providing thermal and noise insulation that is flame-retardant and vapor-permeable.

### SUMMARY OF THE INVENTION

The present invention recognizes and addresses the foregoing disadvantages, and others of prior art constructions and methods. Accordingly, the present invention is generally directed to an insulation blanket that provides thermal and noise insulation to the cabin of an aircraft. In one embodiment, for example, the insulation blanket contains at least one barrier layer positioned adjacent to an insulation layer. An insulation layer of the present invention can generally be made from a variety of materials, such as fibrous or foam insulation materials. For instance, in one embodiment, the insulation layer is made from fiberglass.

As stated, an insulation blanket of the present invention also generally includes at least one barrier layer positioned adjacent to the insulation layer. In one particular embodiment, the insulation layer is sandwiched between two barrier layers to form the insulation blanket.

In general, the barrier layer(s) of the present invention can be made from a film that is attached to a scrim according to any of a variety of methods, such as by stitching, adhesive bonding, taping, etc. Typically, the film of the barrier layer(s) is a polymer film that is vapor-permeable so that moisture can flow through the insulation blanket. For instance, in one embodiment, the polymer film is made from aluminized “MYLAR”, which is also generally flame-retardant.

Moreover, the scrim attached to the film can also be made from any of a variety of generally flame-retardant materials. For instance, in one embodiment, the scrim of a barrier layer is made from yarns formed from a polyester filament produced by Kosa known as AVORA FR Type 692 FR Fiber. Moreover, the yarns forming the scrim of the barrier layer(s) are also generally textured. For instance, in one embodiment, the textured yarns are formed using a false-twist texturizing process. Generally, each strand of yarn can have a denier between about 70 and about 1,200, and particularly between about 100 to about 300. For instance, in one embodiment of the present invention, each strand of yarn made from AVORA FR fibers has a denier of about 150.

The yarn can then be woven into a scrim for use in accordance with the present invention. For example, the resulting scrim can have a variety of weaves, such as basket, twill, satin, plain, Leno, and the like. When utilized, the scrim can generally have any basis weight desired. For instance, in some embodiments, the scrim can have a basis weight less than about 1 ounce per square yard (oz/yd²), and particularly between about 0.25 to about 0.45 oz/yd². In one embodiment, for example, the scrim has a basis weight of about 0.38 oz/yd².

An insulation blanket of the present invention can generally have any of a variety of desired sizes (e.g. length, width, thickness, etc.). For example, the length and/or width of the insulation blanket can vary depending on the dimensions of the aircraft. Moreover, the thickness of the insulation blanket can also vary. For instance, in some embodiments, the thickness of the insulation blanket can be between about 1 to about 4 inches.

Various features and aspects of the present invention are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying figures, in which:

FIG. 1 is a perspective view of one example of an aircraft into which the insulation blankets of the present invention can be incorporated;

FIG. 2 is a perspective view with cutaway portions of one embodiment of a fabric layer of the present invention; and

FIG. 3 is a perspective view with cutaway portions of one embodiment the insulation blanket of the present invention.

Repeat use of reference characters in the present specification and drawings is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention, which broader aspects are embodied in the exemplary construction.

In general, the present invention is directed to an insulation blanket for providing noise and thermal insulation to the inner cabin of an aircraft. In one embodiment, the insulation blanket is formed from an insulation layer sandwiched between two generally flame-retardant barrier layers. For instance, the barrier layers can, in some embodiments, be made from a generally flame-retardant polymer film that is laminated to a generally flame-retardant scrim.

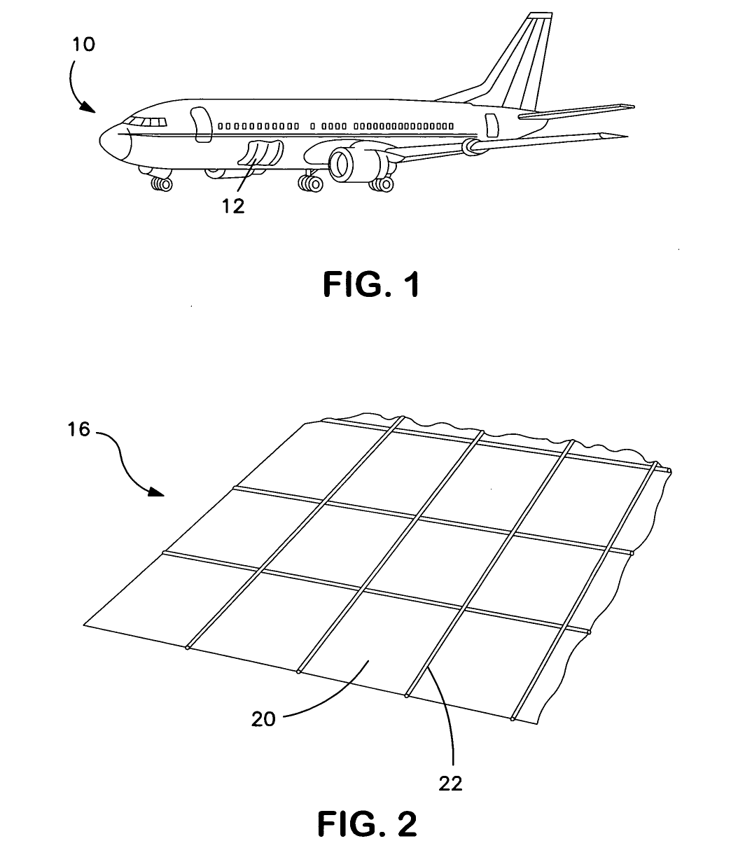

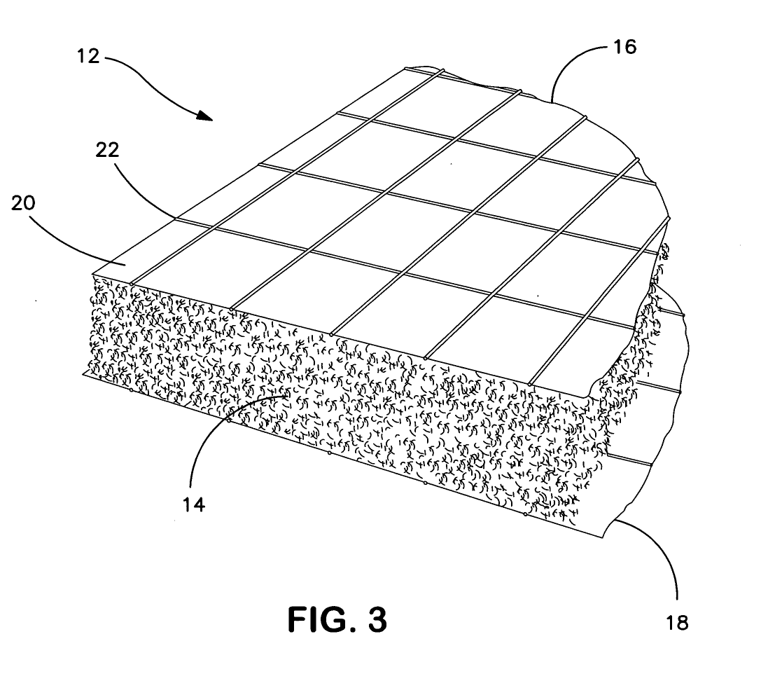

Referring to FIG. 3, for example, one embodiment of an insulation blanket 12 is illustrated. In general, insulation blankets of the present invention can be used in a wide variety of other applications, such as in various types of aircraft. As shown in FIG. 1, for example, the insulation blanket 12 of the present invention can be utilized to insulate the passenger cabin of a commercial passenger aircraft 10. It should be understood, however, that other embodiments are also anticipated and are intended to be covered by this invention.

To insulate the cabin of an aircraft, an insulation blanket of the present invention generally contains at least one layer of an insulation material. For example, as shown in FIG. 3, an insulation layer 14 made from fiberglass is depicted. Besides fiberglass, however, it should be understood that the insulation layer 14 may also be made from any of a variety of other insulation materials, such as described in U.S. Pat. No. 5,759,659 to Sanocki. et al., which is incorporated herein in its entirety by reference thereto. For instance, the insulation layer 14 may include fibrous insulation, foam insulation, or combinations thereof.

Some suitable fibrous insulation materials can include, but are not limited to, fiberglass, polymer fibers (e.g., polypropylene fibers), chopped glass fibers (e.g., magnesium aluminosilicate glass fibers), ceramic oxide fibers (e.g., aluminosilicate ceramic fibers, aluminoboroslicate ceramic oxide fibers, and alumina ceramic oxide fibers), and the like.

In addition to an insulation layer, an insulator blanket of the present invention also includes at least one barrier layer. For instance referring to FIGS. 2-3, the insulation blanket 12 can include a barrier layer 16. In some embodiments, as shown in FIG. 3, the insulation blanket 12 can also include a barrier layer 18 so that the insulation layer 14 is sandwiched between the barrier layer 18 and the barrier layer 16.

In general, the barrier layer(s) of the present invention can be made from any of a variety of generally flame-retardant materials. For instance, in one embodiment, the barrier layers 16 and 18 can contain a generally flame-retardant film 20 attached to a generally flame-retardant scrim 22. The scrim 22 can be attached to the film 20 by any method known in the art, such as by stitching, taping, or by use of an adhesive.

The film 20 can generally be formed from any generally flame-retardant material. Further, the film 20 is typically “vapor-permeable”. As used herein, the term “vapor-permeable” generally refers to a material that allows a vapor, such as water vapor, to pass therethrough. The vapor-permeable films of the present invention are also typically substantially impervious to a liquid. For instance, in one embodiment, the film 20 is a polymer film, such as, aluminized “MYLAR” (i.e., a polyester film) made from DuPont. In another embodiment, a polymer film known as “INSULFAB 210” and obtained from Facile Holdings, Inc., can be utilized. Other suitable materials for the film 20 are described in U.S. Pat. No. 5,759,659 to Sanocki, et al.. Some examples of such materials include, but are not limited to, halogenated polyolefins (e.g., chlorinated and brominated polyethylene), a rubber-toughened ethylene-propylene copolymer compounded with a flame-retardant agent, and the like. Other additives may also be blended with the polymer film, such as other flame-retardant agents, colorants, and melt processing aids.

As stated above, barrier layer(s) of the present invention also include a scrim attached to the film. As used herein, “scrim” generally refers to an open-weave fabric. For instance, as shown in FIGS. 2-3, the barrier layer 16 includes a scrim 22 attached to the film 20. Normally, the scrim 22 is made from a generally flame-retardant material. More particularly, in one embodiment of the present invention, the scrim 22 is made from yarns formed from a polyester filament produced by Kosa known as AVORA FR Type 692 FR Fiber. AVORA FR fibers are made from a generally flame-retardant polyester that contains an organic phosphorus compound in the polyethylene terephthalate chain. However, it should also be understood that other generally flame-retardant yarns can be used to form the scrim 22.

The scrim 22 can generally be formed from flat yarns or textured yarns. The inventor of the present invention, however, has discovered that, in most instances, textured yarns are more suitable in forming the insulation blanket. A variety of well-known methods can be employed to produce various types of textured yarns. For example, textured yarns can be formed using air jets, edge crimping, false-twisting, gear crimping, knit-de-knit, stuffer boxes, etc.. In one particular embodiment, the yarns forming the scrim 22 are texturized using false-twist texturizing.

To produce the textured yarns for the scrim 22, the yarns are first generally unified. In particular, two strands of yarn made from continuous fiber filaments are unified by false-twist texturizing. False twist texturizing involves twisting the feeder yarn in the clockwise direction and subsequently twisting the feeder yarn in the counterclockwise direction. Furthermore, heat is applied to the feeder yarn during each twisting step to provide the yarn with memory, to heat-set the yarn, to draw the yarn, and to properly orient the molecular structure of the yarn. Generally, the amount of heat applied to the feeder yarn depends on the type of fiber used. Normally, it is desired that the temperature of the yarn not exceed its melting point. In one embodiment of the present invention, for example, the feeder yarn made from AVORA FR fibers can be heated to a temperature less than about 482° F., the melting point of the fibers.

Generally, each strand of yarn can have a denier between about 70 and about 1,200, and particularly between about 100 to about 300. For instance, in one embodiment of the present invention, each strand of yarn made from AVORA FR fibers has a denier of about 150.

After forming the yarns, they can then be woven into a scrim for use in accordance with the present invention. Any type of weave can generally be utilized in forming the scrim of the present invention. Some suitable types of weaves include, but are not limited to, basket, twill, satin, plain, Leno, and the like. For example, in one embodiment, the scrim is produced from 150-denier AVORA FR yarn with a Leno weave having approximately 12 ends/inch×6 picks/inch (length×width).

Moreover, after or before forming the scrim, the fabric can be scoured, although scouring may not be necessary for all applications. When utilized, scouring can partially stabilize the fabric by preventing residual shrinkage, as well as clean the fabric by removing water soluble lubricants used in yarn processing and manufacturing that could, in some instances, cause inadequate fire resistance. In addition, the fabric can also be placed on a tenter frame to be dried and heat-set. Generally, heat-setting determines the finished width of the fabric by providing dimensional stability. Specifically, fabrics produced according to the present invention can be heat-set at a temperature between about 350° F. and about 375° F. for approximately one minute.

In general, a scrim formed in accordance with the present invention can be made with various basis weights in order to optimize the properties of the scrim for a particular application. For instance, in some embodiments, the scrim can have a basis weight less than about 1 ounce per square yard (oz/yd²), and particularly between about 0.25 to about 0.45 oz/yd². In one embodiment, for example, the scrim has a basis weight of about 0.38 oz/yd².

In accordance with the present invention, the insulation blanket, such as described above, can generally be formed to have any of a variety of desired sizes (e.g. length, width, thickness, etc.) and/or shapes. For example, the length and/or width of the insulation blanket can vary depending on the dimensions of the aircraft. Moreover, the thickness of the insulation blanket can also vary. For instance, in some embodiments, the thickness of the insulation blanket 12 can be between about 1 to about 4 inches. Once formed, the insulation blanket 12 can be installed into an aircraft in any manner desired. For example, attachment devices, such as described in U.S. Pat. No. 5,811,167 to Norvell, which is incorporated herein in its entirety by reference thereto, can be used in the present invention. For instance, devices, such as straps, that impale the insulation blanket and then attach to the airframe can be used. These attachment devices generally penetrate through the entire insulation blanket. Moreover, the blanket 12 can be installed into new aircraft, as well as being retrofitted to aircraft currently in use.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1-33. (canceled)

34. An insulation blanket for providing thermal and noise insulation to the cabin of an aircraft, said insulation blanket comprising:
a first barrier layer and a second barrier layer, said barrier layers containing a film positioned directly adjacent and laminated to a scrim, said scrim being made from generally flame-retardant polyester textured yarns, said textured yarns having a denier of from about 70 to about 1,200; and
an insulation layer sandwiched between said first barrier layer and said second barrier layer, said insulation layer containing an insulation material.

35. An insulation blanket as defined in claim 34, wherein said yarns have a denier of from about 100 to about 300.

36. An insulation blanket as defined in claim 34, wherein said scrim has a Leno weave.

37. An insulation blanket as defined in claim 34, wherein said scrim has a basis weight of less than about 1 ounce per square yard.

38. An insulation blanket as defined in claim 34, wherein said scrim has a basis weight of from about 0.25 to about 0.45 ounces per square yard.

39. An insulation blanket as defined in claim 34, wherein said film is a polymer film.

40. An insulation blanket as defined in claim 34, wherein said film is a polyester film.

41. An insulation blanket as defined in claim 34, wherein said film is vapor-permeable.

42. An insulation blanket for providing thermal and noise insulation to the cabin of an aircraft, said insulation blanket comprising:
a first barrier layer and a second barrier layer, said barrier layers containing a film positioned directly adjacent and laminated to a scrim, said scrim being made from generally flame-retardant yarns; and
an insulation layer sandwiched between said first barrier layer and said second barrier layer, said insulation layer containing an insulation material.

43. An insulation blanket as defined in claim 42, wherein said yarns are textured.

44. An insulation blanket as defined in claim 42, wherein said yarns are formed from generally flame-retardant polyester fibers.

45. An insulation blanket as defined in claim 42, wherein said yarns have a denier of from about 70 to about 1,200.

46. An insulation blanket as defined in claim 42, wherein said yarns have a denier of from about 100 to about 300.

47. An insulation blanket as defined in claim 42, wherein said scrim has a basis weight of less than about 1 ounce per square yard.

48. An insulation blanket as defined in claim 42, wherein said scrim has a basis weight of from about 0.25 to about 0.45 ounces per square yard.

49. An insulation blanket as defined in claim 42, wherein said film is a vapor-permeable polyester film.

50. An insulation blanket for providing thermal and noise insulation to the cabin of an aircraft, said insulation blanket comprising:
an insulation layer containing an insulation material; and
a barrier layer positioned directly adjacent to said insulation layer, said barrier layer containing a vapor-permeable film positioned adjacent and laminated to a scrim, said scrim being made from generally flame-retardant, textured yarns.

51. An insulation blanket as defined in claim 50, further comprising a second barrier layer positioned adjacent to said insulation layer so that said insulation layer is sandwiched between said barrier layer and said second barrier layer.

52. An insulation blanket as defined in claim 51, wherein said second barrier layer contains a film attached to a scrim, said scrim of said second barrier layer being made from generally flame-retardant, textured yarns.

53. An insulation blanket as defined in claim 50, wherein said textured yarns are formed from generally flame-retardant polyester fibers.

54. An insulation blanket as defined in claim 50, wherein said yarns have a denier of from about 70 to about 1,200.

55. An insulation blanket as defined in claim 50, wherein said yarns have a denier of from about 100 to about 300.

56. An insulation blanket as defined in claim 50, wherein said textured yarns are formed by false-twist texturizing.

57. An insulation blanket as defined in claim 50, wherein said scrim has a basis weight of less than about 1 ounce per square yard.

58. An insulation blanket as defined in claim 50, wherein said scrim has a basis weight of from about 0.25 to about 0.45 ounces per square yard.

59. An insulation blanket as defined in claim 50, wherein said film is a polyester film.

60. An insulation blanket as defined in claim 50, wherein said blanket has a thickness between about 1 to about 4 inches.
